(19) United States
(12) Patent Application Publication
(10) Pub. No.: US 2011/0321111 A1
(43) Pub. Date: Dec. 29, 2011

(54) DYNAMIC LAYOUT OF CONTENT FOR MULTIPLE PROJECTORS

(75) Inventors: Sangwon Chae, Irvine, CA (US); Yasuhiro Komori, Irvine, CA (US); Hung Khei Huang, Irvine, CA (US)

(73) Assignee: CANON KABUSHIKI KAISHA, Tokyo (JP)

(21) Appl. No.: 12/826,628

(22) Filed: Jun. 29, 2010

(51) Int. Cl. H04N 9/31; H04N 7/173

(52) U.S. Cl. 725/117; 348/744; 348/E09.025

(57) ABSTRACT

A projection system distributed on a network, the projection system comprising a projection server and at least one projection client. The projection client hosts a projector array of multiple projectors which together project a tiling of an image onto a projection surface. The projection server accepts an incoming request from the projection client via the network, the request providing the projection server with area information for a projection area of the projector array onto the projection surface. The projection server determines a layout for the image by calculations using the area information. Layout information based on the layout is transmitted via the network to the projection client in response to the request, and image data is projected in accordance with the layout information received from the projection server.

### FIELD

The present disclosure relates to dynamic layout of content for multiple projectors based on a client display area for such projectors, and more particularly relates to the dynamic layout of image content based on a client display area with keystone correction.

### BACKGROUND

Keystone correction is provided in order to correct an image being projected by a projection system, which would otherwise be distorted principally due to an angle of projection from the projection system to the projection screen.

Generally, keystone correction is applied to a projection system so as to obtain a homography transformation that results in good image fidelity between a source image and a projected image. Typically, keystone correcting algorithms determine a maximum area rectangle within a projection area of the projection system, and adjust the source image to fit within the rectangle. Keystone correction can be applied to projection systems having one projector, or having multiple projectors in a projector array.

A more detailed description of a typical keystone correction is provided in “Smarter Presentations: Exploiting Homography in Camera-Projector Systems”, R. Sukthankar, et al., Proceedings of International Conference on Computer Vision (2001) and in “A Self Correcting Projector”, R. Raskar, et al., Mitsubishi Electric Research Laboratories, Inc. (2001).

### SUMMARY

One difficulty in projection systems arises when adjusting the source image to fit within the maximum area rectangle. In this case, the application of a typical keystone correction algorithm often results in the inefficient use of the projection area of the projection system. In addition, the situation is further complicated when there is one source image and multiple projection clients, for example, when the same image is projected at multiple sites. In this situation where there are multiple projection clients, the projection area of one projection client might be different from that of another. In this case, the application of a typical keystone correction algorithm ordinarily results in the inefficient use of each of the different projection areas.

The foregoing situation is addressed by providing a projection server for one or more projection clients. The projection server is provided with area information for the client, of a projection area of a projector array onto a projection surface. The projection server determines a layout for an image by calculations using the area information, and transmits layout information to a projection client.

Thus, in an example embodiment described herein, a projection system distributed on a network includes a projection server and at least one projection client. The projection client hosts a projector array of multiple projectors which together project a tiling of an image onto a projection surface. The projection server accepts an incoming request from the projection client via the network, and the request provides the projection server with area information for a projection area of the projector array onto the projection surface. The projection server determines a layout for the image by calculations using the area information and transmits layout information based on the layout via the network to the projection client in response to the request. The projection client projects image data in accordance with the layout information received from the projection server.

By virtue of this arrangement, it is ordinarily possible to project an image with reduced keystone distortions and without undue waste of the projection area. In addition, it is ordinarily possible to do so regardless of the number of projection clients, and even when the projection area of one projection client is different from that of another.

In one example embodiment, the area information comprises a maximum area rectangle within the projection area of the projector array onto the projection surface. In this case, the projection client includes an image capture device which captures an image of the projection surface, and the projection area of the projection client is detected by corner detection using the image capture device. The maximum area rectangle is determined within the detected projection area. In some example embodiments, the projection client determines the maximum area rectangle by calculations that also include an aspect ratio of an image for projection at the projection client. In some example embodiments, an image for projection at the projection client is divided into sub-images for projection at the projection client by each projector in the projector array. In some example embodiments, a keystone correction is determined for the projection array of the projection client. In example embodiments, the layout information comprises the layout itself.

In another example embodiment, the area information comprises an image of the projection surface and an image of the area projected by each projector in the projector array, and the request also provides the projection server with a resolution of each projector in the projector array and information specifying a location of each projector in the projector array. In this case, the projection client includes an image capture device which captures an image of the projection surface. The projection area of the projection client is detected by corner detection using the image of the projection surface, and the maximum area rectangle is determined within the detected projection area. In some example embodiments, the layout for the image is determined by calculations that include an aspect ratio of an image for projection at the projection client. In some example embodiments, an image for projection at the projection client is divided into sub-images for projection at the projection client by each projector in the projector array. In some example embodiments, a keystone correction is determined for the projector array of the projection client. In example embodiments, the layout information comprises image data for sub-images for projection at the projection client by each projector in the projector array.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a representative view for explaining a projection system relevant to one example embodiment.

FIGS. 2A to 2B are representative views for explaining projection of image data by a projection client relevant to one example embodiment.

FIGS. 3A to 3B are representative views for explaining projection of image data by projection clients having different maximum area rectangles relevant to one example embodiment.

FIG. 4 is a detailed block diagram for explaining the internal architecture of the projection server shown in FIG. 1 according to a first example embodiment.

FIG. 5 is a detailed block diagram for explaining the internal architecture of the projection clients shown in FIG. 1 according to a first example embodiment.

FIG. 6 is a view for explaining software architecture of the projection server and the projection clients according to a first example embodiment.

FIG. 7 is a detailed block diagram for explaining the internal architecture of the projection server shown in FIG. 1 according to a second example embodiment.

FIG. 8 is a detailed block diagram for explaining the internal architecture of the projection clients shown in FIG. 1 according to a second example embodiment.

FIG. 9 is a view for explaining software architecture of the projection server and the projection clients according to a second example embodiment.

FIG. 10 is a flow diagram for explaining processing in a projection client according to a first example embodiment.

FIG. 11 is a flow diagram for explaining processing in a projection server according to a first example embodiment.

FIG. 12 is a flow diagram for explaining processing in a projection client according to a second example embodiment.

FIG. 13 is a flow diagram for explaining processing in a projection server according to a second example embodiment.

FIGS. 14A to 14G illustrate a process according to a first example embodiment.

### DETAILED DESCRIPTION

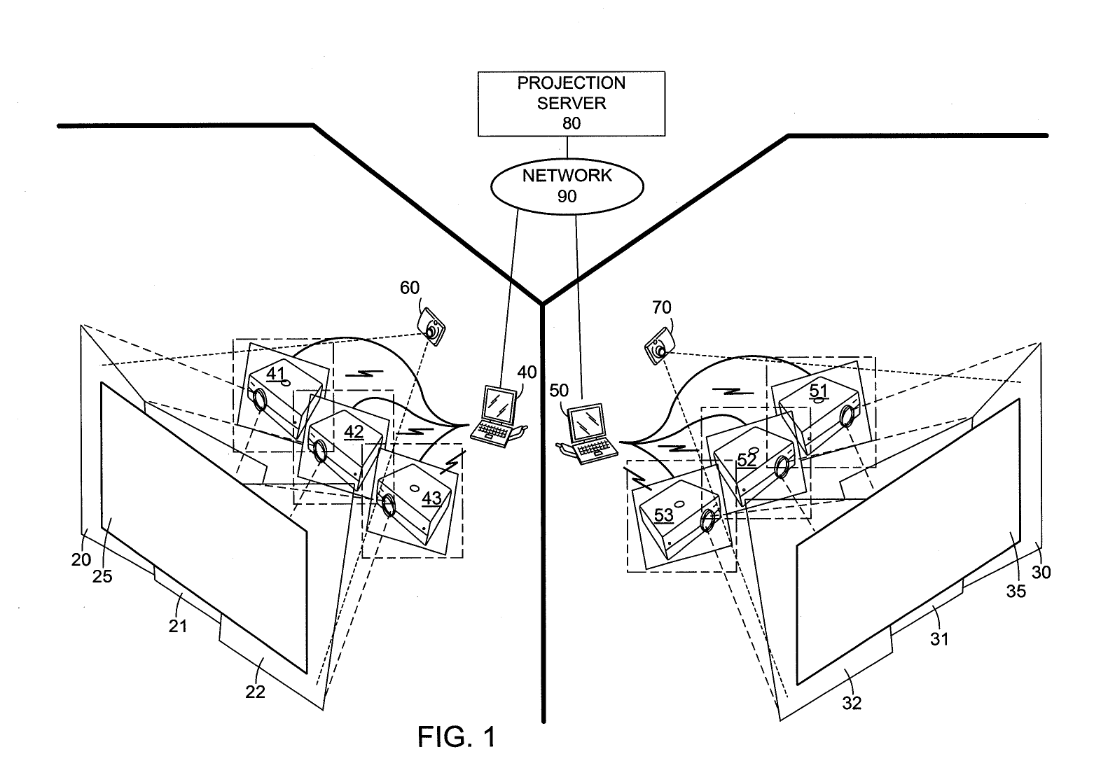

FIG. 1 is a representative view for explaining a projection system including a projection server and at least one projection client hosting a projector array, relevant to one example embodiment.

In particular, the projection system shown in FIG. 1 includes two projection clients, namely projection clients 40 and 50 according to this example embodiment. Projection client 40 generally comprises a programmable general purpose personal computer (hereinafter “PC”) having an operating system such as Microsoft® Windows® or Apple® Mac OS® or LINUX, and which is programmed as described below so as to perform particular functions and in effect to become a special purpose computer when performing these functions. Projection client 40 includes a color monitor including a display screen, a keyboard for entering text data and user commands, and a pointing device. Pointing device preferably comprises a mouse for pointing and for manipulating objects displayed on the display screen.

Projection client 40 also includes computer-readable memory media such as a computer hard disk and a DVD disk drive, which are constructed to store computer-readable information such as computer-executable process steps. The DVD disk drive provides a means whereby the host computer can access information, such as computer-executable process steps, application programs, etc. stored on removable memory media. In an alternative, information can also be retrieved through other computer-readable media such as a USB storage device connected to a USB port, or through a network interface. Other devices for accessing information stored on removable or remote media may also be provided.

Projection client 40 may acquire information from other sources such as a digital camera, a local area network or the Internet via a network interface. Likewise, projection client 40 may interface with color output devices other than projectors 41 to 43, such as color output devices accessible over the network interface.

Projection client 40 acquires image data corresponding to a source image, and provides the image data to each of projectors 41 to 43 such that a corresponding image 25 is displayed on the client projection area, in accordance with layout information received from projection server 80. In addition, the image data is provided for display by projectors 41 to 43 such that the image 25 is substantially aligned with the projection surface, i.e., such that image 25 is keystone corrected. More specifically, projector 41 displays individual projection area 20, projector 42 displays individual projection area 21, and projector 43 displays individual projection area 22. In other words, individual projection areas 20, 21 and 22 are respectively displayed when projectors 41 to 43 independently display white light. Image data is provided to each projector 41 to 43 by projection client 40 such that each of projectors 41 to 43 displays the appropriate portion of the image with reduced keystone distortion across the client projection area on the projection surface.

In this example, projectors 41 to 43 are RGB or RGBW projectors, such as DLP™ digital projectors or other display devices that project images in accordance with image data from the host computer 40 onto a projection surface. Projectors 41 to 43 may be HDR devices capable of projecting HDR images, and may further include, for example, LCD projectors, LCOS projectors, LED projectors.

Together, projectors 41 to 43 make up a projector array, and in accordance with image data received from projection client 40, projectors 41 to 43 project a tiling of an image onto a projection screen by using additive light combinations of red (R), green (G) and blue (B) colorant lights. In addition, and particularly in a case of an HDR device, projectors 41 to 43 also use a white (W) light so as to increase the brightness/luminance of projected images and thereby project HDR images with good fidelity over a large dynamic range.

In this example embodiment, projection client 40 acquires image data corresponding to a source image from projection server 80. Of course, projection client 40 may acquire image data from any other source, including, for example, digital color camera 60.

In this example embodiment, the source image for which the corresponding image data is provided is the same source image for all of the projection clients in the projection system. For example, in the embodiment shown in FIG. 1, the source image for which corresponding image data is provided is the same for projection clients 40 and 50. As described in more detail below, projection server 80 determines a layout for the source image and transmits the layout information based on the layout to the projection client.

Alternatively, in other example embodiments, the source image for which the corresponding image data is provided is a different source image for each projection client in the projection system, or a different source image for each of different groups of projection clients in the projection system. For example, in this case, a first source image is provided for projection client 40, and a second source image is provided for projection client 50 in the embodiment shown in FIG. 1.

Digital color camera 60 is an example of a color input device, and is provided for sending digital image data to projection client 40. In particular, digital color camera 60 captures images of the projection surface of the projector array in order to facilitate control of the multiprojector system.

In this example embodiment, projection client 50 is similar to projection client 40, and digital color camera 70 is similar to digital color camera 60. Therefore, detailed descriptions thereof will be omitted. In addition, projectors 51 to 53 having individual projection areas 30 to 32, respectively, and displaying image 35, are similar to projectors 41 to 43 hosted by projector 40, and detailed descriptions thereof will also be omitted.

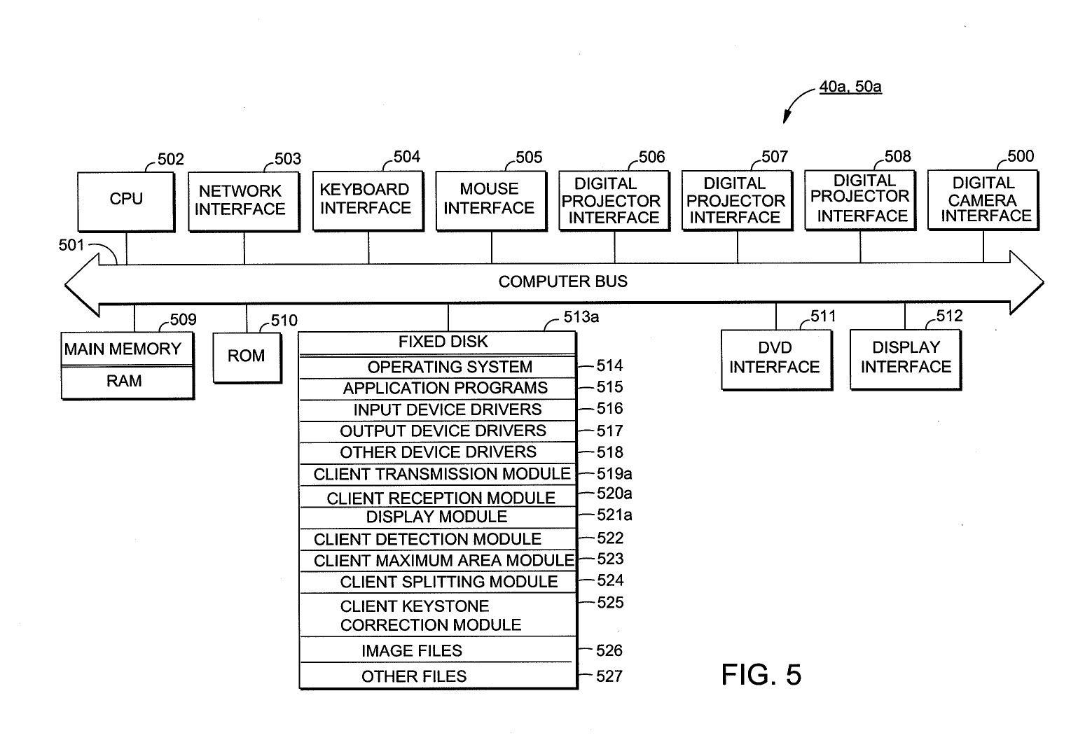

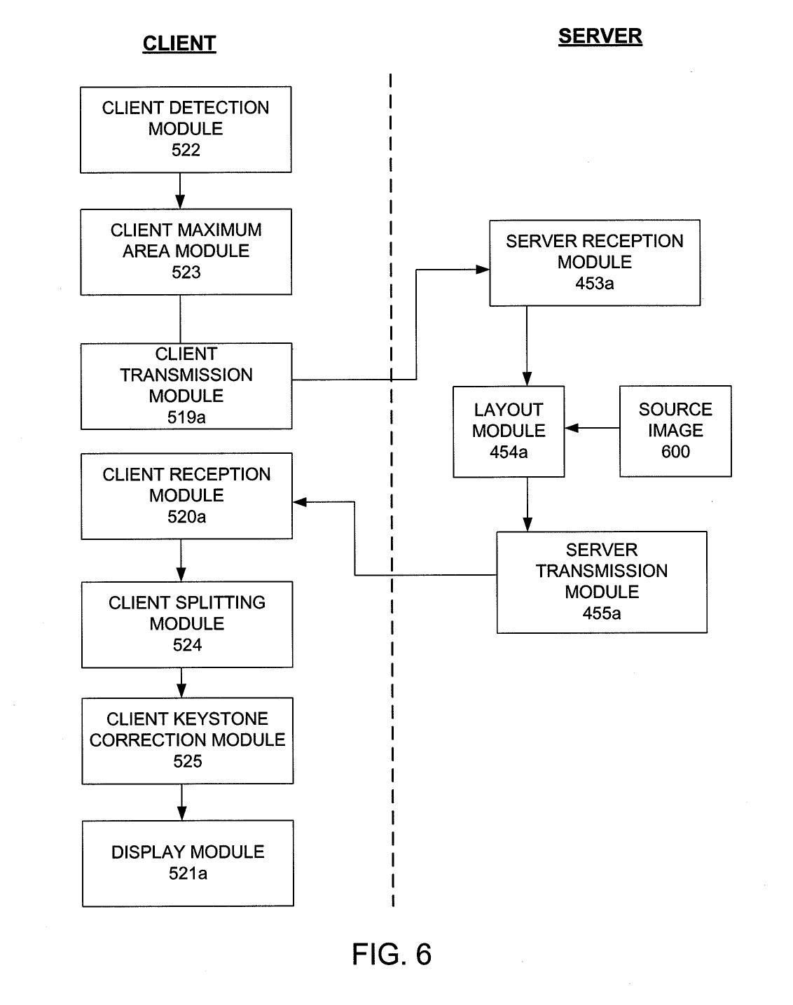

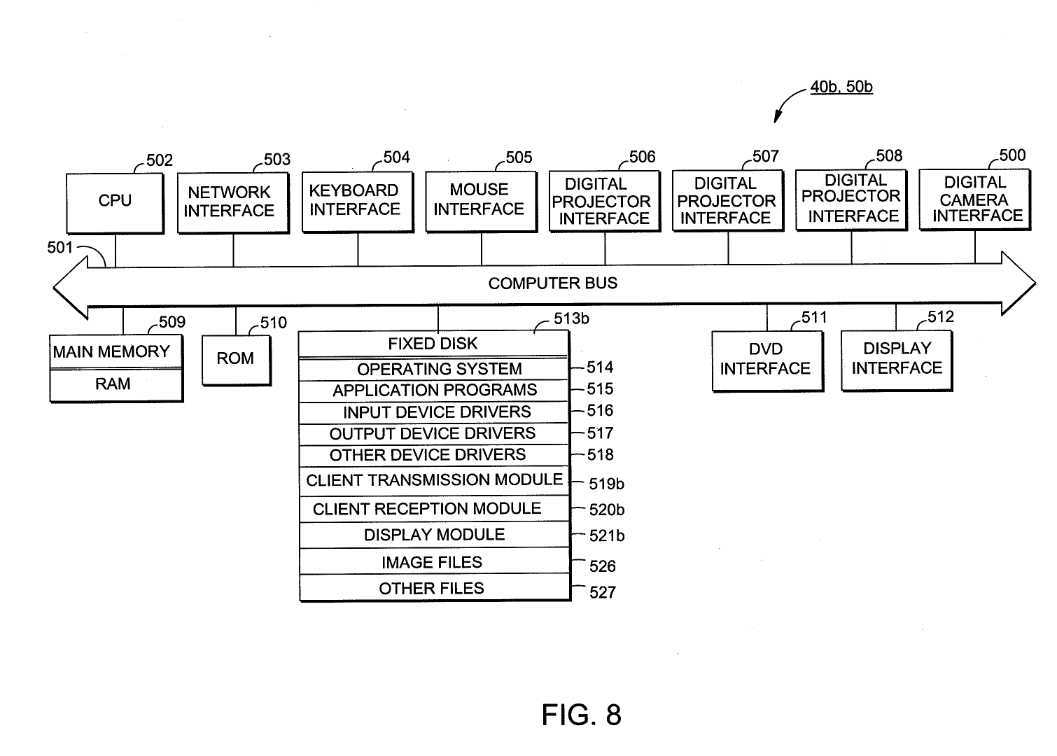

Projection clients 40 and 50 will be described in more detail below, with respect to FIGS. 5 and 8. In particular, the internal architecture of projection clients 40 and 50 according to a first example embodiment will be described with reference to 40a and 50a shown in FIG. 5. The internal architecture of projection clients 40 and 50 according to a second example embodiment will be described with reference to 40b and 50b shown in FIG. 8.

Projection server 80 is constructed to accept an incoming request from the projection client via the network. In particular, in the example shown in FIG. 1, projection server 80 is constructed to accept incoming requests from projection clients 40 and 50 via the network 90. The request provides projection server 80 with area information for a projection area of the projector array onto the projection surface, and the area information is used to determine a layout for a source image. Layout information based on the layout is transmitted via network 90 to the projection client in response to the request by the projection client, and the projection client projects the image data in accordance with the layout information received from projection server 80.

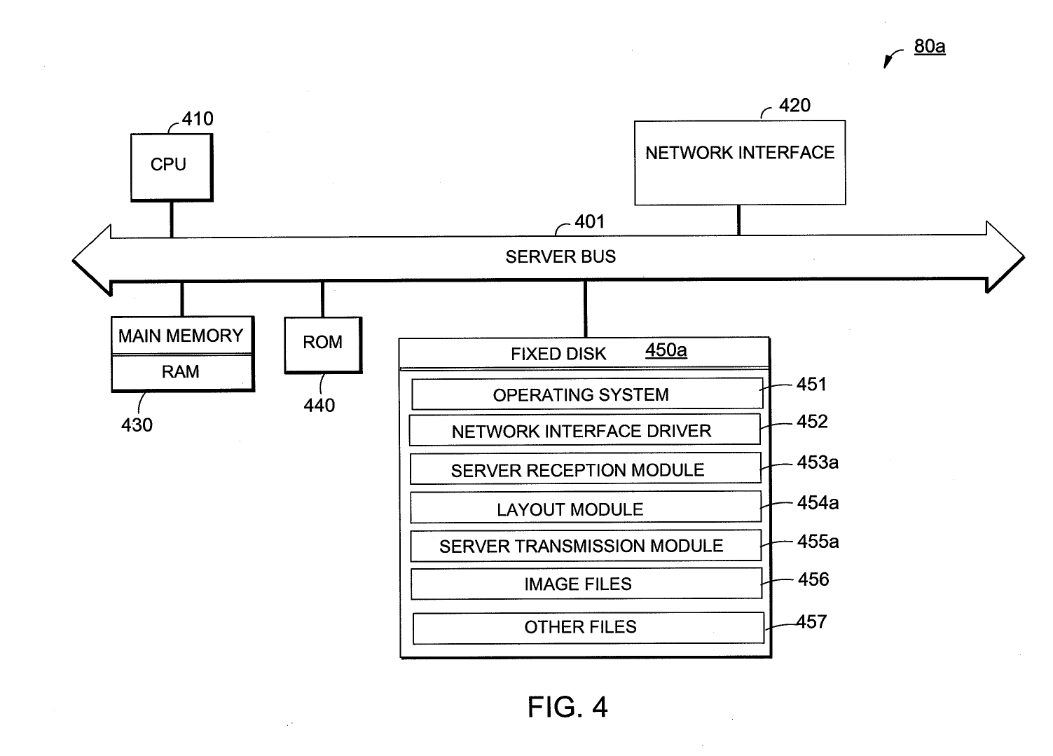

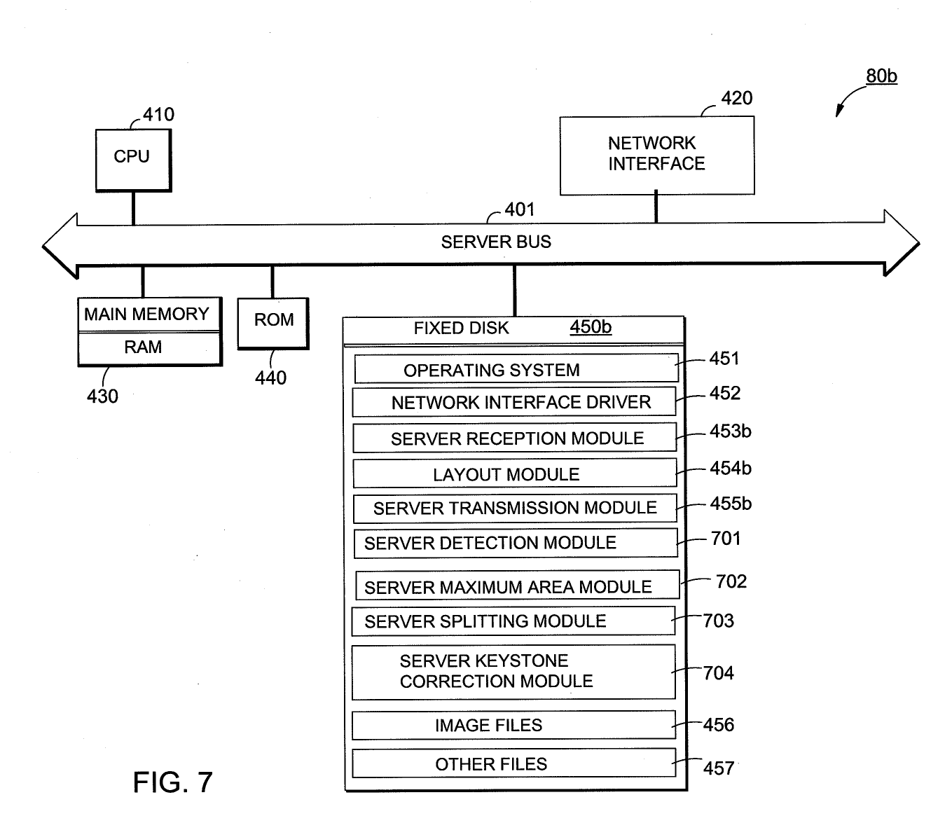

Projection server 80 will be described in more detail below, with respect to FIGS. 4 and 7. In particular, the internal architecture of projection server 80 according to a first example embodiment will be described with reference to 80a shown in FIG. 4. The internal architecture of projection server 80 according to a second example embodiment will be described with reference to 80b shown in FIG. 7.

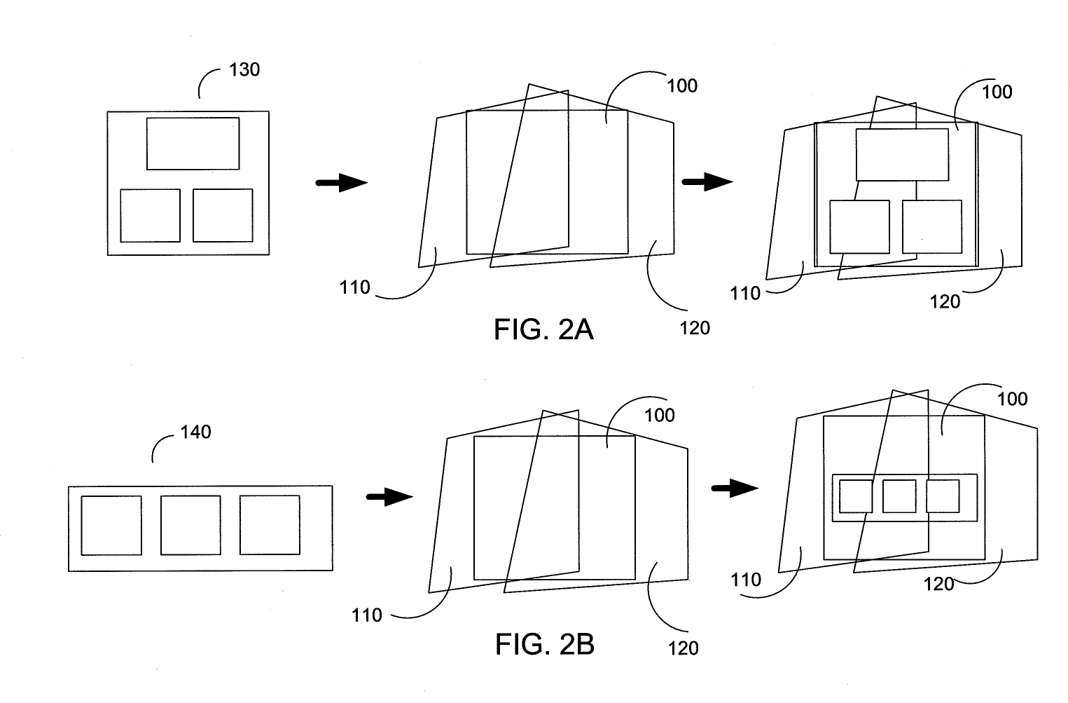

FIGS. 2A to 2B are representative views for explaining projection of image data by a projection client relevant to one example embodiment. In this example embodiment, the projection client hosts two projectors having individual projection areas 110 and 120, respectively, such that the maximum area for displaying an image within the client projection area is represented by maximum area rectangle 100. In this case, a source image having a layout as shown by image 130 will be displayed as shown in FIG. 2A. On the other hand, a source image having a layout as shown by image 140 will be displayed as shown in FIG. 2B.

As shown in FIGS. 2A and 2B, a larger area of the client projection area 100 is utilized when displaying a source image having a layout as shown by image 130, as compared to projection of a source image having a layout as shown by image 140.

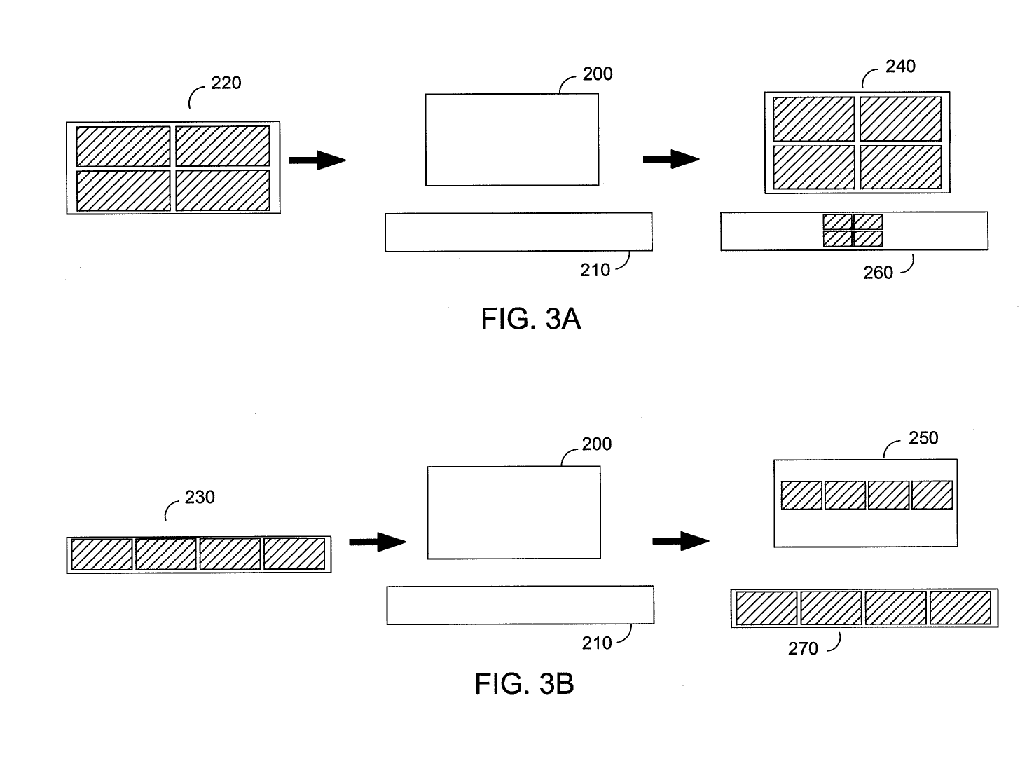

FIGS. 3A to 3B are representative views for explaining projection of image data by projection clients having different maximum area rectangles relevant to one example embodiment. As shown in FIG. 3A, if the maximum area for displaying an image within the projection area of the projection client is represented by maximum area rectangle 200, a source image having a layout as shown by image 220 is displayed as shown by 240. On the other hand, if the maximum area for display is represented by maximum area rectangle 210, the source image having the layout shown by image 220 is displayed as shown by 260. As seen in FIG. 3A, the projection of a source image having a layout as shown by image 220 covers more of client projection area 200, as compared to client projection area 210.

As shown in FIG. 3B, if the maximum area for display within the projection area of the projection client is represented by maximum area rectangle 200, the source image having a layout as shown by image 230 is displayed as shown by 250. On the other hand, if the maximum area for display within the client projection area is represented by maximum area rectangle 210, the source image having the layout shown by image 230 is displayed as shown by 270. As seen in FIG. 3B, the projection of a source image having a layout as shown by image 230 utilizes more of client projection area 210, as compared to client projection area 200.

In this example embodiment, projection server 80 determines a layout for the source image such that the layout is optimal for the projection area of the particular projection client. In this embodiment, the layout of the contents of a source image is considered to be optimal when it is determined that the particular layout maximizes coverage of the client projection area when the corresponding image is projected. In particular, this determination is made by determining a percentage of the client projection area covered by a projected image having a first layout, such as layout 220, and comparing this percentage with a percentage of the client projection area covered by the projected image having a second layout, such as layout 230. The layout which results in coverage of a larger percentage of the client projection area is considered to be optimal. Of course, any other suitable criteria to determine optimization can be used.

Thus, as seen in FIGS. 3A and 3B, the source image having a layout as shown by image 220 is optimal for a client projection area having a maximum area rectangle 200, whereas the source image having a layout as shown by image 230 is optimal for a client projection area having a maximum area rectangle 210.

FIG. 4 is a detailed block diagram for explaining the internal architecture of a projection server according to a first example embodiment. In this first example embodiment, area information provided to the projection server comprises a maximum area rectangle within the projection area of the client's projector array onto the projection surface. According to this example embodiment, the projection server 80 shown in FIG. 1 has an internal architecture as shown by projection server 80a in FIG. 4.

As can be seen in FIG. 4, projection server 80a includes include a central processing unit (“CPU”) 410 such as a programmable microprocessor which interfaces with server bus 401. CPU 410 may be a multi-core CPU. Also interfacing with server bus 401 is a network interface 420 for interfacing to projection clients, such as projection clients 40 and 50. In addition, random access memory (“RAM”) 430, fixed disk 450a, and read-only memory (“ROM”) 440 are coupled to server bus 401. RAM 430 interfaces to server bus 401 to provide CPU 410 with access to memory storage, thereby acting as a main run-time memory for CPU 410. In particular, when executing stored program instruction sequences, CPU 410 loads those instruction sequences from fixed disk 450a (or other memory media) into RAM 430 and execute those stored program instruction sequences out of RAM 430. It should also be recognized that standard disk-swapping techniques can allow segment of memory to be swapped to and from RAM 430 and fixed disk 450a.

ROM 440 stores instruction sequences, such as start-up instruction sequences for CPU 410 or basic input/output operating system (“BIOS”) sequences for the operation of network devices which may be connected to projection server 80a. Network interface 420 contains several modules to provide the appropriate interface functionality for projection server 80a. For example, network interface 420 can contain a network interface layer, which is typically a low-level protocol layer. A TCP/IP layer can be provided above the network interface layer for communicating over network 90 with projection clients 40 and 50 via TCP/IP, a standard network protocol. Other protocols can also be provided to allow projection server 80a to communicate over the network 90 using other conventional protocols. In this regard, is it possible for HTTP protocol, SNMP protocol, and LDAP protocol to be provided in network interface 420 for allowing projection server 80a to communicate to over a network using HTTP, SNMP and LDAP, respectively. However, it should be noted that HTTP, SNMP and LDAP protocols, along with other conventional protocols, can instead be provided by operating system 451. The foregoing protocols can allow for projection server 80a to communicate over a network (e.g., the Internet) with other devices (e.g., projection clients 40 and 50).

Fixed disk 450a is one example of a computer-readable medium that stores program instruction sequences executable by CPU 410 so as to constitute operating system 451, network interface driver 452, and other files 457. Operating system 451 can be an operating system such as DOS, Windows 95, Windows 98, Windows 2000, Windows XP, Windows 7, Windows NT, UNIX, or other such operating system. Network interface driver 452 is utilized to drive network interface 420 for interfacing projection server 80a to projection clients such as projection clients 40 and 50. Other files 457 can contain other files or programs necessary to operate projection server 80a and/or to provide additional functionality to projection server 80a. Additionally, fixed disk 450a stores data for image files 456, which are available for output to projection clients and for manipulation by application programs.

According to the first example embodiment, fixed disk 450a contains computer-executable process steps for at least server reception module 453a, layout module 454a and server transmission module 455a. Server reception module 453a comprises computer-executable process steps executed by a CPU for accepting incoming requests from projection clients 40 and 50 via the network 90, wherein the request provides the projection server 80a with area information for a projection area of the client's projector array onto the projection surface. In this first example embodiment, the area information comprises a maximum area rectangle within the projection area of the client's projector array onto the projection surface. For example, area information for projection client 40 comprises data representing the dimensions of a maximum area rectangle such as maximum area rectangle 200 shown in FIG. 3A. As a second example, area information for projection client 50 may comprise data representing the dimensions of a maximum are rectangle such as maximum are rectangle 210 shown in FIG. 3A.

Layout module 454a comprises computer-executable process steps executed by a CPU for determining a layout for a source image by calculations using the area information provided by the projection client. In this first example embodiment, layout module 454a determines the layout by calculations using the maximum area rectangle provided by the client.

Server transmission module 455a comprises computer-executable process steps executed by a CPU for transmitting layout information based on the determined layout via network 90 to the projection client in response to the request. In this first embodiment, the layout information comprises the layout itself. The projection client projects image data in accordance with the layout information received from projection server 80a.

The computer-executable process steps for server reception module 453a, layout module 454a and server transmission module 455a may be configured as a part of operating system 451, as part of an output device driver such as network interface driver 452, or as a stand-alone application program such as a projection system management system. They may also be configured as a plug-in or dynamic link library (DLL) to the operating system, device driver or application program. It can be appreciated that the present disclosure is not limited to these embodiments and that the disclosed modules may be used in other environments in which control of a multiprojector system is desired.

FIG. 5 is a detailed block diagram for explaining the internal architecture of projection clients according to a first example embodiment. According to this example embodiment, the projection clients 40 and 50 shown in FIG. 1 have an internal architecture as shown by 40a and 50a in FIG. 5. Since the internal architecture of projection client 40 is similar to that of projection client 50 according to this example embodiment, and the following description will be given with respect to projection client 40 only.

As shown in FIG. 5, projection client 40a includes central processing unit (CPU) 502 which may be a multi-core CPU and which interfaces with computer bus 501. Also interfacing with computer bus 501 are fixed disk 513a, network interface 503, random access memory (RAM) 509 for use as a main run-time transient memory, read only memory (ROM) 510, DVD disk interface 511, display interface 512 for a monitor, keyboard interface 504 for a keyboard, mouse interface 505 for a pointing device, digital projector interface 506 for projector 41, digital projector interface 507 for projector 42, digital projector interface 508 for projector 53, and digital camera interface 500 for digital camera 60.

RAM 509 interfaces with computer bus 501 so as to provide information stored in RAM 509 to CPU 502 during execution of the instructions in software programs such as an operating system, application programs, and device drivers. More specifically, CPU 502 first loads computer-executable process steps from fixed disk 513a, or another storage device into a region of RAM 509. CPU 502 can then execute the stored process steps from RAM 509 in order to execute the loaded computer-executable process steps. Data such as color images or other information can be stored in RAM 509, so that the data can be accessed by CPU 502 during the execution of computer-executable software programs, to the extent that such software programs have a need to access and/or modify the data.

As also shown in FIG. 5, fixed disk 513a contains computer-executable process steps for operating system 514, and application programs 515, such as graphic image management programs. Fixed disk 513a also contains computer-executable process steps for device drivers for software interface to devices, such as input device drivers 516, output device drivers 517, and other device drivers 518. Image files 526, including color image files, and other files 527 are available for output to color output devices, such as projectors 41 to 43, and for manipulation by application programs.

Fixed disk 513a contains computer-executable process steps for at least client transmission module 519a, client reception module 520a, and display module 521a. According to the first example embodiment, fixed disk 513a also contains computer-executable process steps for client detection module 522, client maximum area module 523, client splitting module 524 and client keystone correction module 525.

Client detection module 522 comprises computer-executable process steps executed by a computer for detecting the client's projection area by corner detection using an image capture device which captures an image of the projection surface. More specifically, client detection module 522 is constructed to detect a corner of each individual projection area projected by each of projectors 41 to 43. The corner of the individual projection area is detected by causing digital camera 60 to capture an image of each individual projection area projected by each of the projectors in the projector array (e.g., individual projection areas 20 to 22), and analyzing the captured image.

Client maximum area module 523 comprises computer-executable process steps executed by a computer for determining the area information comprising the maximum area rectangle within the projection area detected by the client detection module. In some cases, the aspect ratio of the source image for projection at the projection client may also be used to determine the maximum area rectangle. In this regard, in the case that the source image is provided by projection server 80a, client maximum area module 523 will determine a maximum area rectangle after the image is provided by the projection server 80a.

Client transmission module 519a comprises computer-executable process steps executed by a computer for transmitting a request via network 90 to projection server 80a. The request provides the projection server 80a with area information for a projection area of the client's projector array onto the projection surface. In this first example embodiment, the area information comprises the maximum area rectangle determined by maximum area module 523.

Client reception module 520a comprises computer-executable process steps executed by a computer for receiving layout information based on the layout determined by projection server 80a. In this first example embodiment, the layout information comprises the layout itself.

Client splitting module 524 comprises computer-executable process steps executed by a computer for dividing an image for projection at the projection client into sub-images for projection by each of projectors 41 to 43 in the projector array based on the layout information.

Client keystone correction module 525 comprises computer-executable process steps executed by a computer for determining a keystone correction for the projection array of the projection client. More specifically, a homography transformation is derived for each of projectors 41 to 43 in order to facilitate keystone correction. Client keystone correction module 525 derives a homography transformation, and an inverse of the derived homography transformation for each of the projectors 41 to 43 in the projector array.

Display module 521a comprises computer-executable process steps executed by a computer for projecting image data corresponding to the source image in accordance with the layout information received from the projection server 80a. In this first example embodiment, the layout information comprises the layout itself. Display module 521a provides image data which has been divided by client splitting module 524 and adjusted by client keystone correction module 525 to each of the projectors 41 to 43 in the client's projector array for display based on the layout information received from the projection server 80a.

The computer-executable process steps for client transmission module 519a, client reception module 520a, display module 521a, client detection module 522, client maximum area module 523, client splitting module 524 and client keystone correction module 525 may be configured as a part of operating system 514, as part of an output device driver such as a projector driver, or as a stand-alone application program such as a multiprojector management system. These modules may also be configured as a plug-in or dynamic link library (DLL) to the operating system, device driver or application program. For example, client transmission module 519a, client reception module 520a, display module 521a, client detection module 522, client maximum area module 523, client splitting module 524 and client keystone correction module 525 according to example embodiments may be incorporated in an output device driver for execution in a computing device, such as a projector driver, embedded in the firmware of an output device, such as a projector, or provided in a stand-alone application for use on a general purpose computer. In one example embodiment described herein, client transmission module 519a, client reception module 520a, display module 521a, client detection module 522, client maximum area module 523, client splitting module 524 and client keystone correction module 525 are incorporated directly into the operating system for projection client 40a. It can be appreciated that the present disclosure is not limited to these embodiments and that the disclosed modules may be used in other environments in which control of a multiprojector system is desired.

FIG. 6 is a view for explaining software architecture of the projection server 80a and the projection clients 40a and 50a according to the first example embodiment. In this regard, the software architecture of projection client 40a is similar to that of projection client 50a according to this example embodiment, and therefore the following description will be given with respect to projection client 40a only.

As shown in FIG. 6, client detection module 522 included in the projection client 40a is constructed to detect the projection area of the client by corner detection using an image capture device, e.g., digital cameras 60 and 70, which captures an image of the projection surface. More specifically, client detection module 522 causes digital camera 60 to capture an image of each individual projection area (e.g., 20 to 22) projected by each of the projectors 41 to 43 in the projector array, and analyzes the captured image. Client detection module 522 accepts, as input, the image data captured by digital camera 60, and outputs coordinates for each of the corners of each of the individual projection areas 20 to 22 displayed by the projectors 41 to 43. More specifically, one projector at a time is controlled to display white light, and digital camera 60 captures an image of the individual projection area displayed by the one projector.

In this embodiment, the corners of each of the individual projection areas on the projection surface are detected by analyzing the captured image using, for example, a Canny algorithm to determine the coordinates of each of the corners of the individual projection areas. Of course, any other suitable method of detecting the corners of the projection areas displayed on a projection surface may be used.

Client maximum area module 523 accepts, as input, the coordinates of the corners of each individual projection area. Based on these coordinates, client maximum area module 523 outputs coordinates indicating a maximum area rectangle on which an image can be displayed within the projection area of the projector array.

In particular, in this embodiment, the maximum area rectangle is calculated by using a rectangle. In some example embodiments in which the aspect ratio is used in order to detect the maximum area rectangle, a rectangle having the same aspect ratio as the source image is used. Based on the coordinates of the corners of each individual projection area, the edges of the projection area of the projector array are determined. The rectangle is inscribed beginning at the upper left corner of the projection area of the projector array, such that the rectangle meets the projection area at two edges. The size of the rectangle is increased, until a point on the rectangle meets a third edge of the projection area. The process is then repeated beginning at the upper right corner of the object, and the results of the two processes are compared such that coordinates indicating the position of a maximum area rectangle within the projection area of the projector array are determined. While the above-discussed process has been provided here as an example, any suitable method of determining the maximum area rectangle for display may be used.

Client transmission module 519a accepts, as input, the coordinates representing the maximum area rectangle, and transmits a request via network 90 to projection server 80a. In this first example embodiment, the request provides the projection server 80a with area information comprising the maximum area rectangle for a projection area of the client's projector array determined by maximum area module 523.

Server reception module 453a accepts the request including the area information, which in this first example embodiment comprises the maximum area rectangle from the projection client, and provides the area information to layout module 454a.

Layout module 454a receives, as input, source image 600 and the area information, which in this first example embodiment comprises the maximum area rectangle. Layout module 454a then determines a layout for the source image 600 which is optimal for the client's projection area by calculations using the maximum area rectangle received from the projection client. Layout module 454a re-formats the contents of the source image according to the layout which is determined to be optimal, and outputs layout information based on the determined layout. In this first example embodiment, the layout information comprises data representing the layout itself.

In this example embodiment, layout module 454a determines the layout for the image automatically. More specifically, using a decision making algorithm, layout module 454a determines the layout for source image 600 such that the contents of source image 600 are laid out in a reasonable manner and such that the layout of the contents is optimal based on the maximum are rectangle provided by the client request. The decision making algorithm may use any suitable method or criteria, including, for example, performing a layout analysis on the contents of source image 600. Alternatively, the layout of the image contents may be determined based on templates, or based on the relationship between objects in the source image 600. Additionally, information may be provided in the metadata of the source image which indicates one or more layouts which are suitable for the contents of the image. Of course, any other suitable method of determining the optimized layout may be used.

Server transmission module 455a receives, as input, the layout information determined by layout module 454a, and transmits the layout information via network 90 to the projection client 40a. In this first example embodiment, the layout information comprises data representing the layout itself.

Client reception module 520a receives layout information based on the layout from server transmission module 455a, and provides the layout information to client splitting module 524. In this first example embodiment, the layout information comprises data representing the layout itself.

Client splitting module 524 receives, as input, the layout information from client reception module 520a, and divides the source image 600 into sub-images for projection by each of the projectors 41 to 43 in the projector array based on the layout information, and based on the individual projection areas projected by each of the projectors 41 to 43 in the projector array. The source image 600 is divided such that when projectors 41 to 43 project their respective sub-images, an image corresponding to source image 600 having a layout as determined by projection server 80a is displayed.

Client keystone correction module 525 receives, as input, the sub-images output from client splitting module 524, and outputs adjusted sub-images for display by each of projectors 41 to 43. More specifically, client keystone correction module 525 comprises computer-executable process steps to derive homography transformations for each of the sub-images provided to projectors 41 to 43, and inverse homography transformations for each of the projectors in the client's projector array. Client keystone correction module 525 applies the inverses of the derived homography transformations to the image data for each corresponding sub-image in order to facilitate keystone correction.

Display module 521a receives the adjusted sub-images from client keystone correction module 525, and provides the image data for each sub-image to the corresponding projector in the projector array, such that each projector displays the appropriate portion of the image within the maximum area rectangle on the projection screen, and such that the image is substantially aligned with the projection screen. Thus, a keystone corrected image which corresponds to source image 600 and which has a layout as determined by projection server 80a is projected by the projection client.

FIG. 7 is a detailed block diagram for explaining the internal architecture of the projection server according to a second example embodiment. In this second example embodiment, area information provided to the projection server 80 comprises an image of the projection surface and an image of the area projected by each projector in the projector array. According to this example embodiment, the projection server 80 shown in FIG. 1 has an internal architecture as shown by projection server 80b in FIG. 7.

As can be seen in FIG. 7, projection server 80b includes include a central processing unit (“CPU”) 410 such as a programmable microprocessor which interfaces with server bus 401. CPU 410 may be a multi-core CPU. Also interfacing with server bus 401 is a network interface 420 for interfacing to projection clients, such as projection clients 40 and 50. In addition, random access memory (“RAM”) 430, fixed disk 450b, and read-only memory (“ROM”) 440 are coupled to server bus 401. RAM 430 interfaces to server bus 401 to provide CPU 410 with access to memory storage, thereby acting as a main run-time memory for CPU 410. In particular, when executing stored program instruction sequences, CPU 410 loads those instruction sequences from fixed disk 450b (or other memory media) into RAM 430 and execute those stored program instruction sequences out of RAM 430. It should also be recognized that standard disk-swapping techniques can allow segment of memory to be swapped to and from RAM 430 and fixed disk 450b.

ROM 440 stores instruction sequences, such as start-up instruction sequences for CPU 410 or basic input/output operating system (“BIOS”) sequences for the operation of network devices which may be connected to server 80b. Network interface 420 contains several modules to provide the appropriate interface functionality for projection server 80b. For example, network interface 420 can contain a network interface layer, which is typically a low-level protocol layer. A TCP/IP layer can be provided above the network interface layer for communicating over network 90 with projection clients 40 and 50 via TCP/IP, a standard network protocol. Other protocols can also be provided to allow projection server 80b to communicate over the network 90 using other conventional protocols. In this regard, is it possible for HTTP protocol, SNMP protocol , and LDAP protocol to be provided in network interface 420 for allowing projection server 80b to communicate to over a network using HTTP, SNMP and LDAP, respectively. However, it should be noted that HTTP, SNMP and LDAP protocols, along with other conventional protocols, can instead be provided by operating system 451. The foregoing protocols can allow for projection server 80b to communicate over a network (e.g., the Internet) with other devices (e.g., projection clients 40 and 50).

Fixed disk 450b is one example of a computer-readable medium that stores program instruction sequences executable by CPU 410 so as to constitute operating system 451, network interface driver 452, and other files 457. Operating system 451 can be an operating system such as DOS, Windows 95, Windows 98, Windows 2000, Windows XP, Windows 7, Windows NT, UNIX, or other such operating system. Network interface driver 452 is utilized to drive network interface 420 for interfacing projection server 80b to projection clients such as projection clients 40 and 50. Other files 457 can contain other files or programs necessary to operate projection server 80b and/or to provide additional functionality to projection server 80b. Additionally, fixed disk 450b stores data for image files 456, which are available for output to projection clients and for manipulation by application programs.

Fixed disk 450b contains computer-executable process steps for at least server reception module 453b, layout module 454b and server transmission module 455b. In this second example embodiment, fixed disk 450b also contains computer-executable process steps for server detection module 701, server maximum area module 702, server splitting module 703 and server keystone correction module 704.

Server reception module 453b is constructed to accept an incoming request from the projection client via the network 90, wherein the request provides the projection server 80b with area information for a projection area of the projector array onto the projection surface. In this second example embodiment, area information comprises an image of the projection surface and an image the individual projection area projected by each projector in the projector array. In this case, the request also provides the projection server with a resolution of each projector in the projector array and information specifying a location of each projector in the projector array.

Server detection module 701 comprises computer-executable process steps executed by a CPU for detecting the client's projection area by corner detection using the area information comprising the image of the projection surface and the image of the area projected by each projector in the projector array. More specifically, server detection module 701 is constructed to detect a corner of each individual projection area projected by each of projectors 41 to 43.

Server maximum area module 702 comprises computer-executable process steps executed by a CPU for determining the maximum area rectangle within the projection area detected by the server detection module 701. In some cases, the aspect ratio of the source image for projection at the projection client may also be used to determine the maximum area rectangle.

Layout module 454b comprises computer-executable process steps executed by a CPU for determining a layout for a source image by calculations using the area information provided by the projection client. In this second example embodiment, layout module 454b determines the layout by calculation using the maximum area rectangle derived from the area information comprising the image of the projection surface and the image the individual projection area projected by each projector in the projector array. In this case, layout module 454b also uses the resolution of each projector in the projector array and the information specifying the location of each projector in the projector array.

Server splitting module 703 comprises computer-executable process steps executed by a CPU for dividing an image, based on the layout determined by layout module 454b, for projection at the projection client into sub-images for projection at the projection client by each projector in the projector array.

Server keystone correction module 704 comprises computer-executable process steps executed by a CPU for determining a keystone correction for the projection array of the projection client. More specifically, a homography transformation is derived for each of the projectors in the client's projector array in order to facilitate keystone correction. Server keystone correction module 704 derives a homography transformation, and an inverse of the derived homography transformation for each of the projectors in the projector array.

Server transmission module 455b comprises computer-executable process steps executed by a CPU for transmitting layout information based on the determined layout via network 90 to the projection client in response to the request. In this second embodiment, the layout information comprises image data for sub-images for projection at the projection client by each projector in the projector array. The projection client projects image data in accordance with the layout information received from projection server 80b.

The computer-executable process steps for server reception module 453b, layout module 454b, server transmission module 455b, server detection module 701, server maximum area module 702, server splitting module 703 and server keystone correction module 704 may be configured as a part of operating system 451, as part of an output device driver such as network interface driver 452, or as a stand-alone application program such as a projection system management system. These modules may also be configured as a plug-in or dynamic link library (DLL) to the operating system, device driver or application program. It can be appreciated that the present disclosure is not limited to these embodiments and that the disclosed modules may be used in other environments in which control of a multiprojector system is desired.

FIG. 8 is a detailed block diagram for explaining the internal architecture of the projection clients according to the second example embodiment. According to this example embodiment, the projection clients 40 and 50 shown in FIG. 1 have an internal architecture as shown by 40b and 50b in FIG. 8. Since the internal architecture of projection client 40 is similar to that of projection client 50 according to this example embodiment, the following description will be given with respect to projection client 40 only.

As shown in FIG. 8, projection client 40b includes central processing unit (CPU) 502 which may be a multi-core CPU and which interfaces with computer bus 501. Also interfacing with computer bus 501 are fixed disk 513b, network interface 503, random access memory (RAM) 509 for use as a main run-time transient memory, read only memory (ROM) 510, DVD disk interface 511, display interface 512 for a monitor, keyboard interface 504 for a keyboard, mouse interface 505 for a pointing device, digital projector interface 506 for projector 41, digital projector interface 507 for projector 42, digital projector interface 508 for projector 53, and digital camera interface 500 for digital camera 60.

RAM 509 interfaces with computer bus 501 so as to provide information stored in RAM 509 to CPU 502 during execution of the instructions in software programs such as an operating system, application programs, and device drivers. More specifically, CPU 502 first loads computer-executable process steps from fixed disk 513b, or another storage device into a region of RAM 509. CPU 502 can then execute the stored process steps from RAM 509 in order to execute the loaded computer-executable process steps. Data such as color images or other information can be stored in RAM 509, so that the data can be accessed by CPU 502 during the execution of computer-executable software programs, to the extent that such software programs have a need to access and/or modify the data.

As also shown in FIG. 5, fixed disk 513b contains computer-executable process steps for operating system 514, and application programs 515, such as graphic image management programs. Fixed disk 513b also contains computer-executable process steps for device drivers for software interface to devices, such as input device drivers 516, output device drivers 517, and other device drivers 518. Image files 526, including color image files, and other files 527 are available for output to color output devices, such as projectors 41 to 43, and for manipulation by application programs.

In the second example embodiment, fixed disk 513b contains computer-executable process steps for client transmission module 519b, client reception module 520b, and display module 521b.

Client transmission module 519b comprises computer-executable process steps executed by a computer for transmitting a request via the network 90 to the projection server 80b. The request provides the projection server with area information for a projection area of the projector array onto the projection surface. In this second example embodiment, the area information comprises an image of the projection surface and an image of the area projected by each projector in the projector array. In this case, the request also provides the projection server with a resolution of each projector in the projector array and information specifying a location of each projector in the projector array.

Client reception module 520b comprises computer-executable process steps executed by a computer for receiving layout information based on a layout determined by projection server 80b. In this second example embodiment, the layout information comprises image data for sub-images for projection at the projection client by each projector in the projector array.

Display module 521b comprises computer-executable process steps executed by a computer for projecting image data corresponding to the source image in accordance with the layout information received from the projection server 80b. In this second example embodiment, the layout information comprises image data for sub-images for projection at the projection client by each projector 41 to 43 in the projector array. Display module 521b provides the sub-images provided by client reception module 520b to each projector in the projector array for display.

The computer-executable process steps for client transmission module 519b, client reception module 520b, and display module 521b may be configured as a part of operating system 514, as part of an output device driver such as a projector driver, or as a stand-alone application program such as a multiprojector management system. These modules may also be configured as a plug-in or dynamic link library (DLL) to the operating system, device driver or application program. For example, client transmission module 519b, client reception module 520b and display module 521b according to example embodiments may be incorporated in an output device driver for execution in a computing device, such as a projector driver, embedded in the firmware of an output device, such as a projector, or provided in a stand-alone application for use on a general purpose computer. In one example embodiment described herein, client transmission module 519b, client reception module 520b and display module 521b are incorporated directly into the operating system for projection client 40b. It can be appreciated that the present disclosure is not limited to these embodiments and that the disclosed modules may be used in other environments in which control of a multiprojector system is desired.

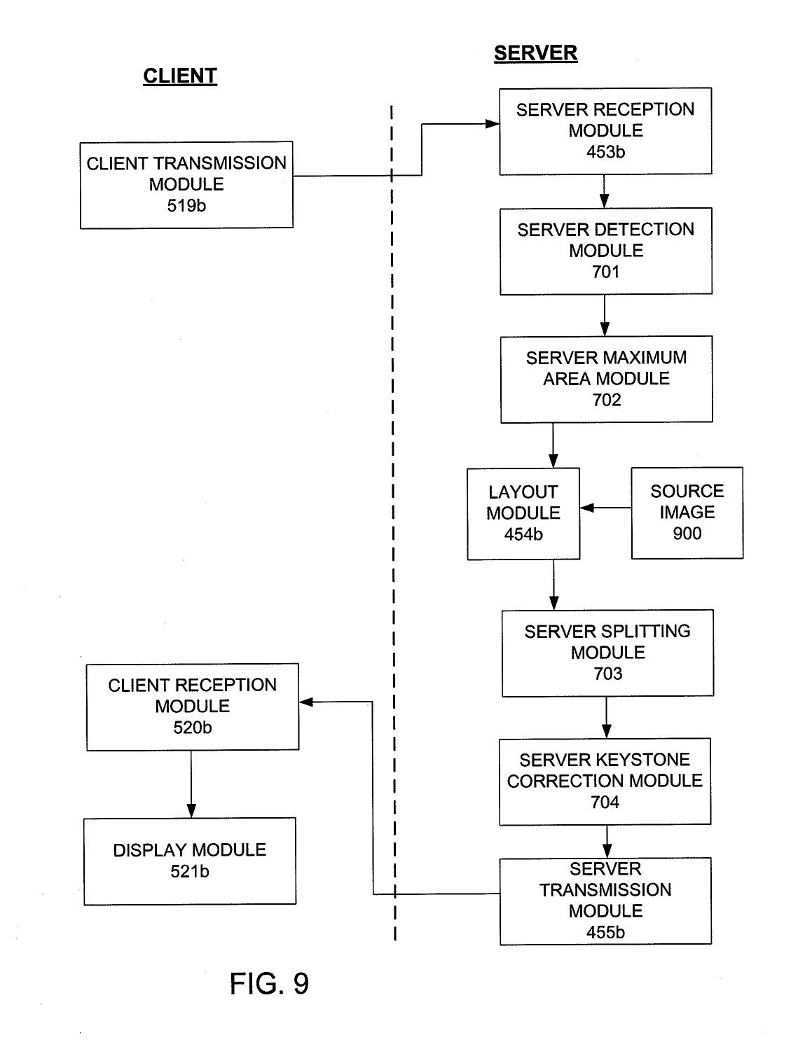

FIG. 9 is a view for explaining software architecture of the projection server 80b and the projection clients 40b and 50b according to the second example embodiment. In this regard, the software architecture of projection client 40b is similar to that of projection client 50b according to this example embodiment, and therefore the following description will be given with respect to projection client 40b only.

As shown in FIG. 9, client transmission module 519b included in the projection client 40b is constructed to transmit a request via the network 90 to projection server 80b. The request provides the projection server 80b with area information for a projection area of the projector array onto the projection service. In this second example embodiment, the area information comprises an image of the projection surface and an image of the area projected by each projector in the projector array. Client transmission module 519b uses an image capture device (e.g., digital cameras 60 and 70) to capture the images. In this case, the request also provides the projection server 80b with a resolution of each projector in the projector array and information specifying a location of each projector in the projector array.

In order to capture an image of the projection surface, an image is captured of the projection area projected by all of projectors 41 to 43 in the projector array. More specifically, the computer-executable process steps of client transmission module 519b cause projectors 41 to 43 to display white light, such that all of individual projection areas 20 to 22 are displayed, and cause digital camera 60 to capture an image of the resulting projection area.

In order to capture the image of the individual projection area projected by each projector in the projector array, one projector at a time is controlled to display white light, and digital camera 60 captures an image of the individual projection area displayed by the one projector.

Server reception module 453b included in the projection server 80b accepts the request including the area information, which in this second example embodiment comprises the image of the projection surface and the image of the area projected by each projector in the projector array, and provides the area information to server detection module 701.

Server detection module 701 accepts, as input, the image data captured by the image capture device, and outputs coordinates for each of the corners of each of the individual projection areas 20 to 22 displayed by the projectors 41 to 43. More specifically, server detection module 701 is constructed to detect the projection area of the projection client by corner detection using the area information comprising the image of the projection surface and the image of the area projected by each projector in the projector array.

In this embodiment, the corners of each of the individual projection areas on the projection surface are detected by analyzing the captured image using, for example, a Canny algorithm to determine the coordinates of each of the corners of the individual projection areas. Of course, any other suitable method of detecting the corners of the projection areas displayed on a projection surface may be used.

Server maximum area module 702 accepts, as input, the coordinates of the corners of each individual projection area from server detection module 701. Based on these coordinates, server maximum area module 702 outputs coordinates indicating a maximum area rectangle on which an image is displayed within the projection area of the projector array.

In particular, in this embodiment, the maximum area rectangle is calculated by using a rectangle. In some example embodiments in which the aspect ratio is used in order to detect the maximum area rectangle, a rectangle having the same aspect ratio as the source image is used. Based on the coordinates of the corners of each individual projection area, the edges of the projection area of the projector array are determined. The rectangle is inscribed beginning at the upper left corner of the projection area of the projector array, such that the rectangle meets the projection area at two edges. The size of the rectangle is increased, until a point on the rectangle meets a third edge of the projection area. The process is then repeated beginning at the upper right corner of the projection area, and the results of the two processes are compared such that coordinates indicating the position of a maximum area rectangle within the projection area of the projector array are determined. While the above-discussed process has been provided here as an example, any suitable method of determining the maximum area rectangle for display may be used.

Layout module 454b receives, as input, source image 900 and the maximum area rectangle output from server maximum area module 702. Layout module 454b then determines a layout for the source image 900 which is optimal for the client's projection area based on the maximum area rectangle derived from the area information. Layout module 454b re-formats the contents of the source image according to the layout which is determined to be optimal, and outputs layout information based on the determined layout. In this second example embodiment, the layout information comprises image data for sub-images for projection at the projection client by each projector in the projector array.

In this example embodiment, layout module 454b determines the layout for the image automatically. More specifically, using a decision making algorithm, layout module 454b determines the layout for source image 900 such that the contents of source image 900 are laid out in a reasonable manner and such that the layout of the contents is optimal based on the maximum are rectangle provided by the client request. The decision making algorithm may use any suitable method or criteria, including, for example, performing a layout analysis on the contents of source image 900. Alternatively, the layout of the image contents may be determined based on templates, or based on the relationship between objects in the source image 900. Additionally, information may be provided in the metadata of the source image which indicates one or more layouts which are suitable for the contents of the image. Of course, any other suitable method of determining the optimized layout may be used.

Server splitting module 703 receives, as input, the layout information from layout module 454b. Server splitting module 703 divides the source image 900 into sub-images for projection by each of the projectors 41 to 43 in the projector array, based on the layout information and based on the individual projection areas projected by each of the projectors 41 to 43 in the projector array. The source image 900 is divided such that when projectors 41 to 43 project their respective sub-images, an image corresponding to source image 900 having a layout as determined by projection server 80b is displayed.

Server keystone correction module 704 receives, as input, the sub-images output from server splitting module 703, and outputs adjusted sub-images for display by each of projectors 41 to 43. More specifically, server keystone correction module 704 comprises computer-executable process steps to derive homography transformations for each of the sub-images provided to projectors 41 to 43, and inverse homography transformations for each of the projectors in the client's projector array. Server keystone correction module 704 further comprises computer-executable process steps to apply the inverses of the derived homography transformations to the image data for each corresponding sub-image in order to facilitate keystone correction.

Server transmission module 455b receives, as input, the adjusted sub-images determined by server keystone correction module 704, and transmits data representing the adjusted sub-images via network 90 to the projection client 40b. Thus, in this second example embodiment, the layout information comprises image data for sub-images for projection at the projection client by each projector in the projector array.

Client reception module 520b receives the layout information, which in this second embodiment comprises the image data for sub-images for projection at the projection client, and provides the data for the sub-images to display module 521b.

Display module 521b receives the adjusted sub-images from client reception module 520b, and provides the image data for each sub-image to the corresponding projector in the projector array, such that each projector displays the appropriate portion of the image on the maximum area rectangle on the projection screen, and such that the image is substantially aligned with the projection screen. Thus, a keystone corrected image which corresponds to source image 900 and which has a layout as determined by projection server 80b is projected by the projection client.

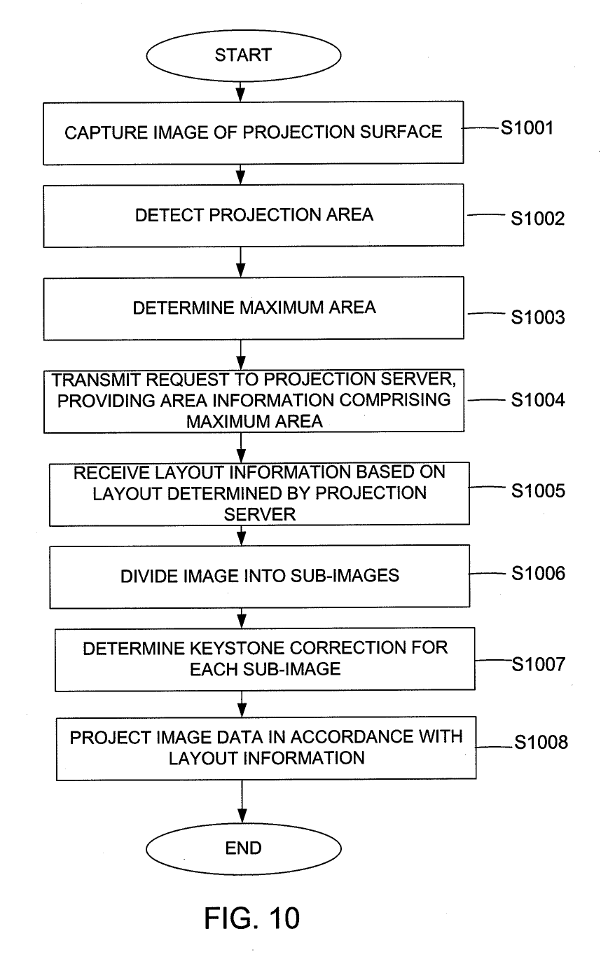

FIG. 10 is a flow diagram for explaining processing in a projection client according to the first example embodiment, in which the area information provided to projection server 80a comprises the maximum area rectangle. As shown in FIG. 10, in step S1001, a projection client (e.g., projection clients 40a and 50a) uses an image capture device (e.g., digital cameras 60 and 70) in order to capture an image of the projection surface. More specifically, client detection module 522 causes the image capture device to capture an image of each individual projection area (e.g., 20 to 22 and 30 to 32) projected by each of the projectors in the projector array. In step S1002, client detection module 522 detects the client projection area by analyzing the captured images using, for example, a Canny algorithm to determine the coordinates of each of the corners of the individual projection areas, as described above with respect to FIG. 6.

The flow then proceeds to step S1003 where client maximum area module 523 determines a maximum area rectangle within the projection area detected in step S1002, according to the process described above with respect to FIG. 6.

In step S1004, client transmission module 519a transmits a request to the projection server 80a, wherein the request includes area information comprising the maximum area rectangle determined in step S1003.

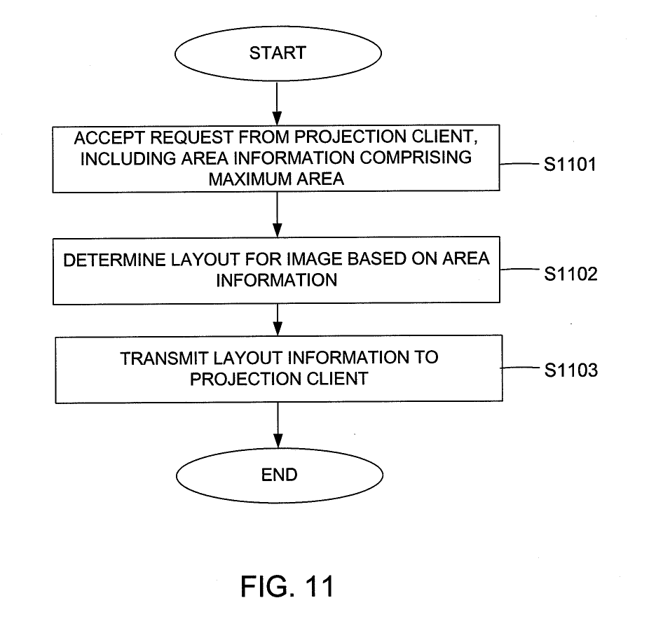

In step S1005, client reception module 520a receives layout information based on the layout determined by projection server 80a. In the first example embodiment, the layout information comprises information representing the layout itself. The layout determination process performed by projection server 80a is described below with respect to FIG. 11.

The flow then proceeds to step S1006, where client splitting module 524 divides the source image 600 into sub-images for projection by each of the projectors in the projector array based on the layout information received in step S1005. In step S1007, client keystone correction module 525 derives homography transformations and inverses of the derived homography transformations, and applies the inverse homography transformations to each of the corresponding sub-images divided in step S1006 in order to facilitate keystone correction.

In step S1008, display module 521a provides the image data for each keystone corrected sub-image to the corresponding projector in the projector array, such that a keystone corrected image corresponding to the source image 600 and having a layout as determined by projection server 80a is projected.

FIG. 11 is a flow diagram for explaining processing in a projection server according to the first example embodiment, in which the area information provided to projection server 80a comprises the maximum area rectangle. As shown in FIG. 11, in step S1101, server reception module 453a accepts the request providing the area information from the projection client. More specifically, server reception module 453a accepts the request which is transmitted by the projection client in step S1004 of FIG. 10.

In step S1102, layout module 454a determines the optimal layout for the source image 600 by calculations using the maximum area rectangle provided by the projection client. The process by which the layout module 454a determines the layout is performed according to the process described above with respect to FIG. 6.

The flow then proceeds to step S1103, where server transmission module 455a transmits layout information based on the layout which is determined to be optimal in step S1102. In this first example embodiment, the layout information comprises the layout itself. The layout information transmitted by server transmission module 455a is received by client reception module 520a in step S1005 of FIG. 10.

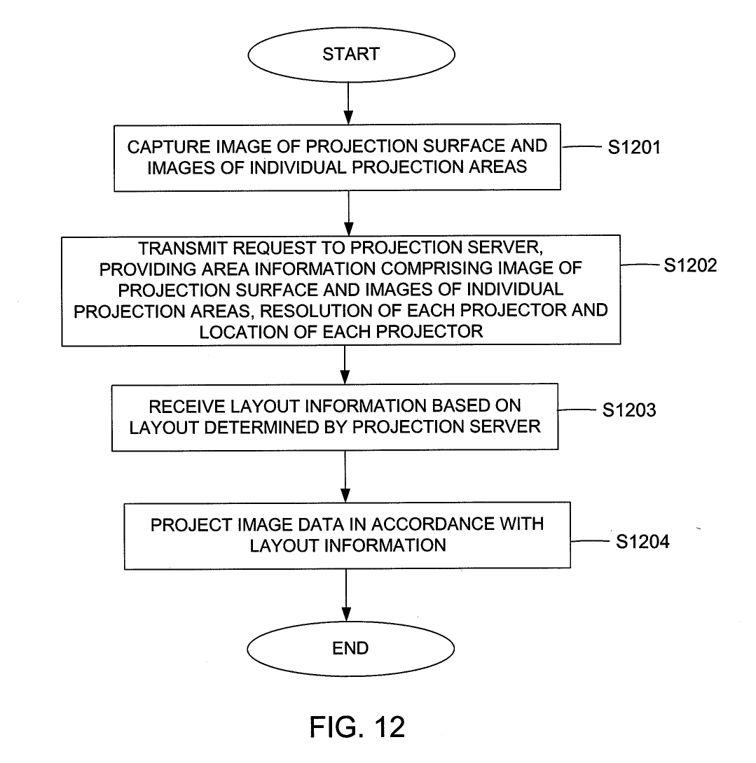

FIG. 12 is a flow diagram for explaining processing in a projection client according to the second example embodiment, in which the area information provided to the projection server 80b comprises an image of the projection surface and an image of the area projected by each projector in the projector array. As shown in FIG. 12, in step S1201, client transmission module 519b uses an image capture device (e.g., digital cameras 60 and 70) to capture images of the projection surface. In particular, an image is captured of the projection surface where all of the individual projection areas of the projectors in the projector array are displayed, and an image is captured of each of the individual projection areas of the projectors in the projector array, as described above with respect to FIG. 9.

In step S1202, client transmission module 519b transmits a request to the projection server 80b, wherein the request includes area information comprising the images captured in step S1201, namely the image of the projection surface and the image of the area projected by each projector in the projector array. In this second example embodiment, the request also provides the projection server with a resolution of each projector in the projector array and information specifying a location of each projector in the projector array.

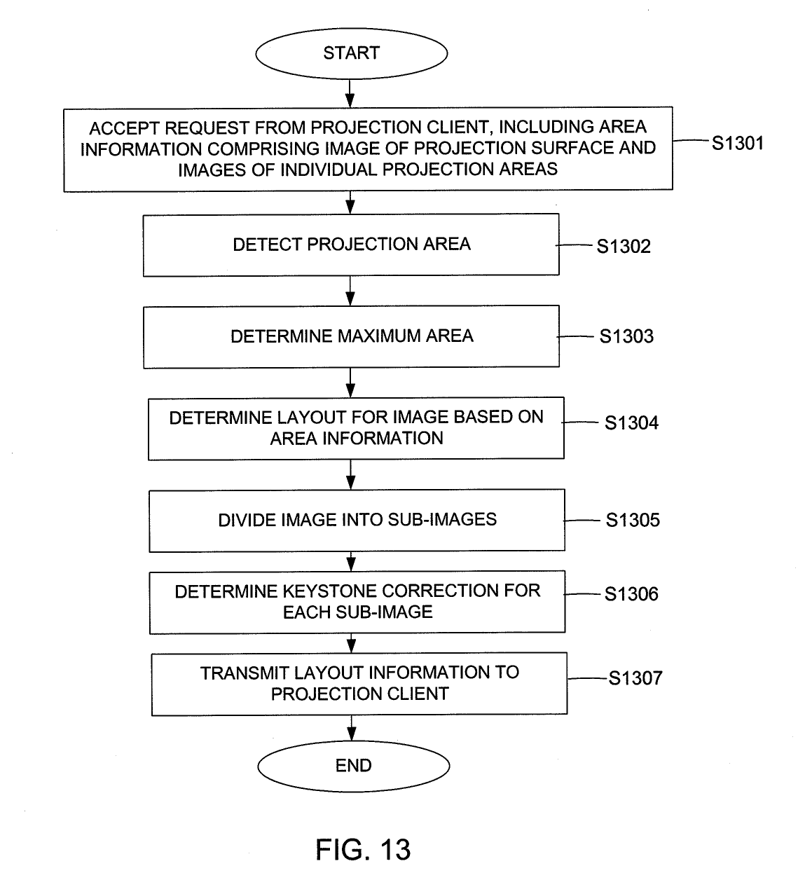

In step S1203, client reception module 520b receives layout information based on the layout determined by projection server 80b. In the second example embodiment, the layout information comprises image data for sub-images for projection by each projector in the client's projector array. The layout determination process performed by projection server 80b is described below with respect to FIG. 13.

The process then proceeds to step S1204, where display module 521b provides image data for each sub-image to the corresponding projector in the projector array for display.

FIG. 13 is a flow diagram for explaining processing in a projection server according to the second example embodiment, in which the area information provided to the projection server 80b comprises an image of the projection surface and an image of the area projected by each projector in the projector array. As shown in FIG. 13, in step S1301, server reception module 453b accepts the request providing the area information from the projection client. More specifically, server reception module 453b accepts the request which is transmitted by the projection client in step S1202 of FIG. 12.

In step S1302, server detection module 701 detects the client projection area by analyzing the area information comprising the image of the projection surface and the images of the individual projection areas of each projector in the projector array. Server detection module 701 analyzes the captured images using, for example, a Canny algorithm to determine the coordinates of each of the corners of the individual projection areas, as described above with respect to FIG. 9.

In step S1303, server maximum area module 702 determines a maximum area rectangle within the projection area detected in step S1302, according to the process described above with respect to FIG. 9.

In step S1304, layout module 454b determines the optimal layout for the source image 600 by calculations using the maximum area rectangle determined in step S1303. The process by which the layout module 454b determines the layout is performed according to the process described above with respect to FIG. 9.

In step S1305, server splitting module 703 divides the source image 900 into sub-images for projection by each of the projectors in the projector array based on the layout determined in step S1304. In step S1306, server keystone correction module 704 derives homography transformations and inverses of the derived homography transformations, and applies the inverse homography transformations to each of the corresponding sub-images divided in step S1305 in order to facilitate keystone correction.

The flow then proceeds to step S1307, where server transmission module 455b transmits layout information based on the layout which is determined to be optimal in step S1304. In this second example embodiment, the layout information comprises image data for the sub-images divided in step S1305 and keystone corrected in step S1306. The layout information transmitted by server transmission module 455b is received by client reception module 520b in step S1203 of FIG. 12.

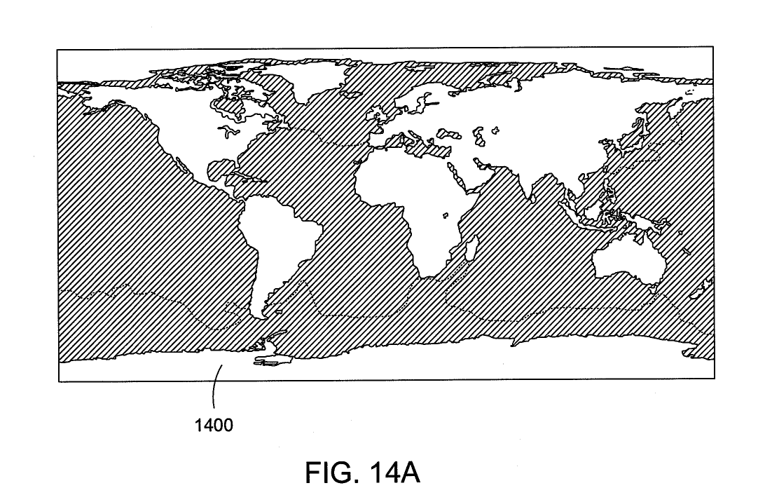

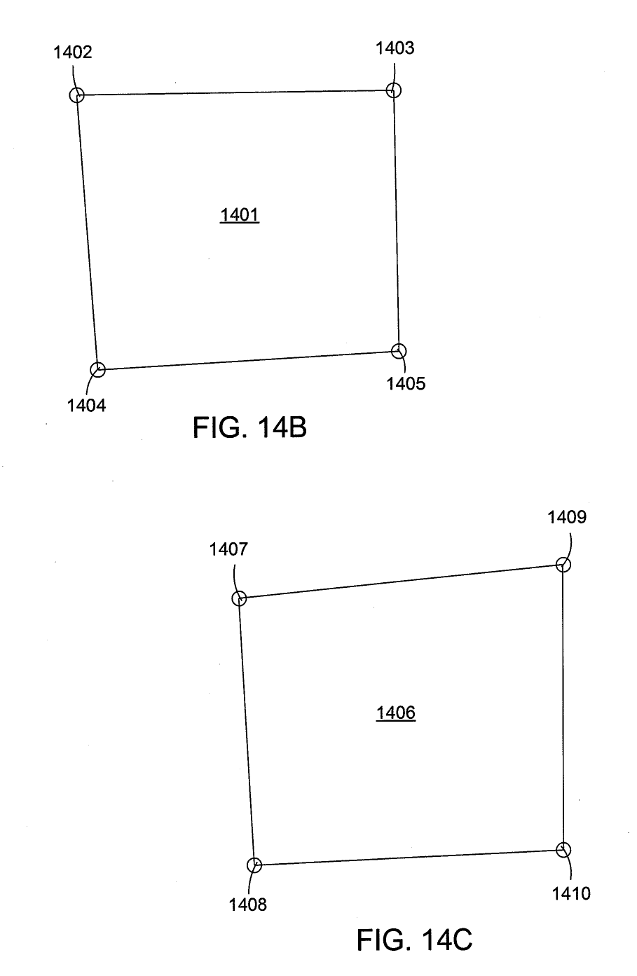

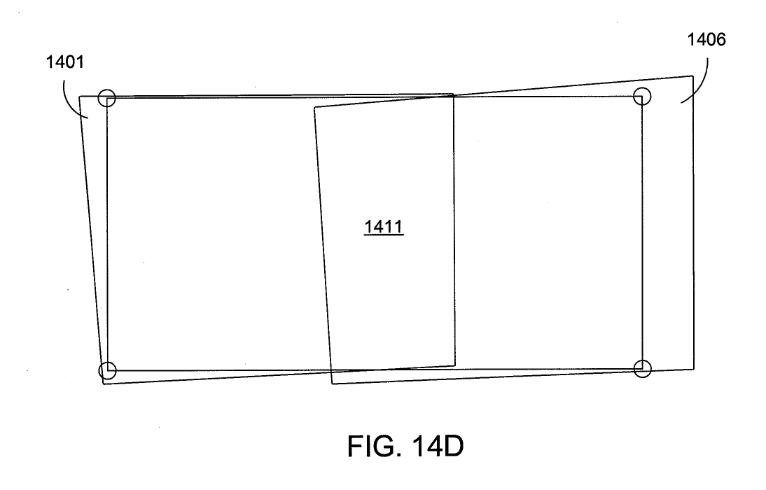

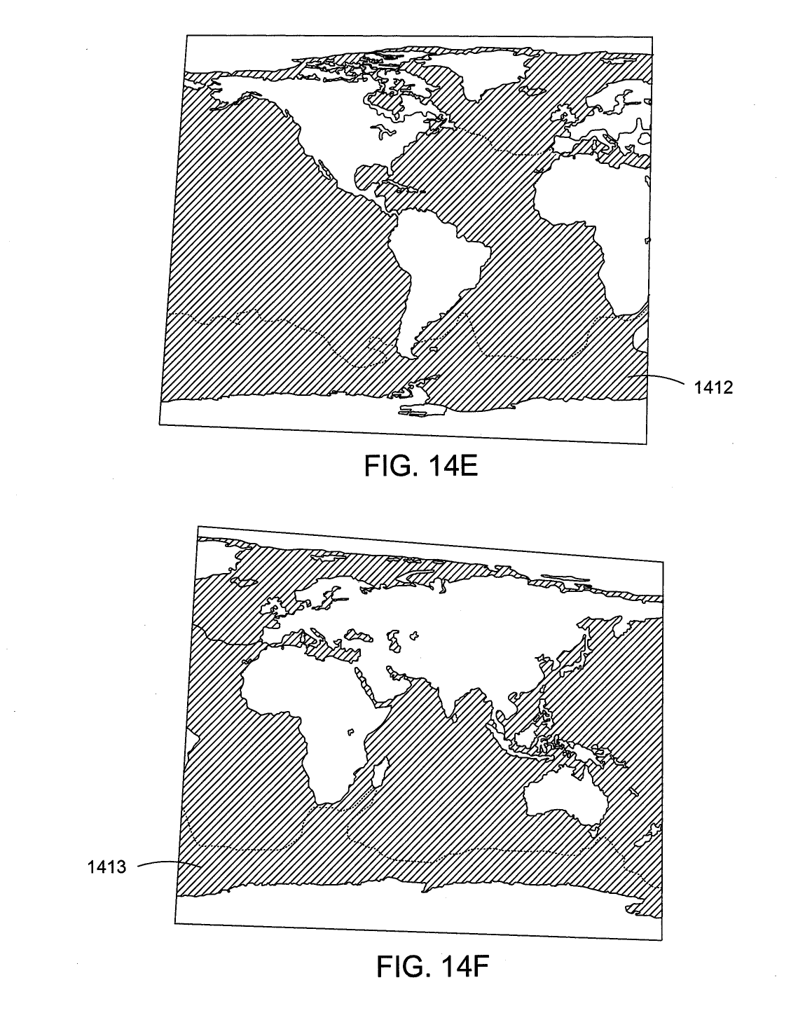

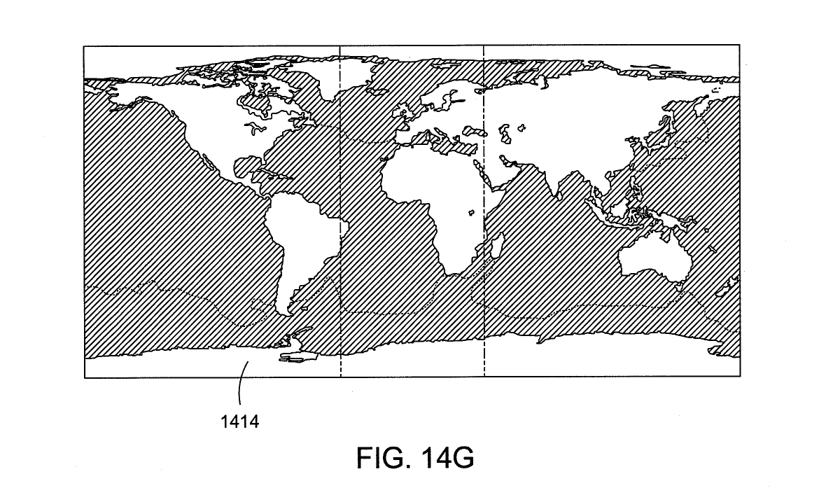

FIGS. 14A to 14G illustrate the process according to the first example embodiment in which the area information provided to the projection server 80a comprises a maximum are rectangle within the projection area of the projector array.

More specifically, FIG. 14A depicts an example source image 1400. FIGS. 14B and 14C illustrate steps S1001 and S1002 from FIG. 10. More specifically, as shown in FIG. 14B, an image is captured of a first individual projection area 1401 projected by a first projector in the projector array. The projection client analyzes the captured image using a Canny algorithm to determine the coordinates of each of the corners of individual projection area 1401. These coordinates are represented in FIG. 14B by reference numerals 1402 to 1405. Similarly, as shown in FIG. 14C, an image is captured of a second individual projection area 1406. The projection client analyzes the captured image using a Canny algorithm to determine the coordinates of each of the corners of individual projection area 1401. These coordinates are represented in FIG. 14C by reference numerals 1407 to 1410.

FIG. 14D illustrates the process by which the projection client determines its maximum area rectangle (e.g., step S1003 in FIG. 10) according to the process described above with respect to FIG. 6. As shown in FIG. 14D, individual projection areas 1401 and 1406 are such that the maximum area for displaying an image within the client projection area is represented by maximum area rectangle 1411.

In the first example embodiment, area information comprising the maximum area rectangle 1411 is provided to the projection server 80a (e.g., step S1004 in FIG. 10 and step S1101 in FIG. 11), and the projection server 80a determines an optimal layout for the source image 600 by calculations using the area information (e.g., step S1102 in FIG. 11). Projection server 80a then provides the layout information based on the determined layout to the projection client (e.g., step S1103 in FIG. 11 and step S1005 in FIG. 10). According to the first example embodiment, the layout information comprises the layout itself.

FIGS. 14E and 14F illustrate the processes encompassed by steps S1006 and S1007 in FIG. 10. In particular, the projection client divides the source image 1400, based on the layout information, into sub-images for projection by each of the projectors in the projector array. As shown in FIGS. 14E and 14F, source image 1400 is divided into sub-images for projection by each projector in the client's projector array. The projection client then derives homography transformations and inverses of the derived homography transformations, and applies the inverse homography transformations to each of the corresponding sub-images, resulting in keystone corrected sub-images 1412 and 1413.

FIG. 14G illustrates projection of the sub-images by each of the projectors in the projector array. More specifically, image data for each keystone corrected sub-image (e.g., 1412 and 1413) is provided to the corresponding projector in the projector array. Thus, sub-image 1412 is provided for display to the projector having individual projection area 1401, and sub-image 1413 is provided for display to the projector having individual projection area 1406, resulting in image 1414 corresponding to source image 1400. As shown in FIG. 14G, projected image 1414 corresponds to source image 1400, and is projected with keystone correction having a layout determined by projection server 80a.

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A projection system distributed on a network comprising:
at least one projection client, wherein the client hosts a projector array of multiple projectors which together project a tiling of an image onto a projection surface; and
a projection server constructed to accept an incoming request from the projection client via the network, wherein the request provides the projection server with area information for a projection area of the projector array onto the projection surface,
wherein the projection server is constructed to determine a layout for the image by calculations using the area information and to transmit layout information based on the layout via the network to the projection client in response to the request, and
wherein the projection client projects image data in accordance with the layout information received from the projection server.

2. The system according to claim 1, wherein the area information comprises a maximum area rectangle within the projection area of the projector array onto the projection surface.

3. The system according to claim 2, wherein the projection client includes an image capture device which captures an image of the projection surface, and wherein the projection client detects its projection area by corner detection using the image capture device and determines the area information comprising the maximum area rectangle within the projection area detected thereby.

4. The system according to claim 2, wherein the projection client determines the area information comprising the maximum area rectangle by calculations that include an aspect ratio of an image for projection at the projection client.

5. The system according to claim 2, wherein the projection client divides the image for projection at the projection client into sub-images for projection at the projection client by each projector in the projector array based on the layout information.

6. The system according to claim 2, wherein the projection client determines a keystone correction for the projection array of the projection client.

7. The system according to claim 2, wherein the layout information comprises the layout itself.

8. The system according to claim 1, wherein the projection client includes an image capture device which captures an image of the projection surface,
wherein the area information comprises an image of the projection surface and an image of the area projected by each projector in the projector array, and
wherein the request also provides the projection server with a resolution of each projector in the projector array and information specifying a location of each projector in the projector array.

9. The system according to claim 8, wherein the projection server detects the projection area by corner detection using the area information comprising the image of the projection surface and the image of the area projected by each projector in the projector array, and determines a maximum area rectangle within the projection area detected thereby.

10. The system according to claim 8, wherein the projection server determines the layout by calculations that include an aspect ratio of an image for projection at the projection client.

11. The system according to claim 8, wherein the projection server divides an image for projection at the projection client into sub-images for projection at the projection client by each projector in the projector array based on the layout information.

12. The system according to claim 8, wherein the layout determined by the projection server also includes a keystone correction for the projector array of the projection client.

13. The system according to claim 8, wherein the layout information comprises image data for sub-images for projection at the projection client by each projector in the projector array.

14. A projection server comprising:
a network interface for communicating with at least one projection client over a network, wherein the projection client hosts a projector array of multiple projectors which together project a tiling of an image onto a projection surface;
a server reception module constructed to accept an incoming request from the projection client via the network, wherein the request provides the projection server with area information for a projection area of the projector array onto the projection surface;
a layout module constructed to determine a layout for the image by calculations using the area information; and
a server transmission module constructed to transmit layout information based on the layout via the network to the projection client in response to the request,
wherein the projection client projects image data in accordance with the layout information received from the projection server.

15. The projection server according to claim 14, wherein the projection client includes an image capture device which captures an image of the projection surface,
wherein the area information comprises an image of the projection surface and an image of the area projected by each projector in the projector array, and
wherein the request also provides the projection server with a resolution of each projector in the projector array and information specifying a location of each projector in the projector array.

16. The projection server according to claim 15, further comprising:
a server detection module constructed to detect the projection area by corner detection using the area information comprising the image of the projection surface and the image of the area projected by each projector in the projector array; and
a server maximum area module constructed to determine the maximum area rectangle within the projection area detected by the server detection module.

17. The projection server according to claim 14, wherein the server layout module determines the layout by calculations that include an aspect ratio of an image for projection at the projection client.

18. The projection server according to claim 14, further comprising:
a server splitting module constructed to divide an image for projection at the projection client into sub-images for projection at the projection client by each projector in the projector array based on the layout information.

19. The projection server according to claim 14, further comprising:
a server keystone correction module constructed to determine a keystone correction for the projection array of the projection client.

20. The projection server according to claim 14, wherein the layout information comprises image data for sub-images for projection at the projection client by each projector in the projector array.

21. A projection client, comprising:
a network interface for communicating with a projection server over a network, wherein the projection client hosts a projector array of multiple projectors which together project a tiling of an image onto a projection surface;
a client transmission module constructed to transmit a request via the network to the projection server, wherein the request provides the projection server with area information for a projection area of the projector array onto the projection surface;
a client reception module constructed to receive layout information based on a layout, wherein the projection server determines the layout for the image by calculations using the area information; and
a display module constructed to project image data in accordance with the layout information received from the projection server

22. The projection client according to claim 21, wherein the area information comprises a maximum area rectangle within the projection area of the projector array onto the projection surface.

23. The projection client according to claim 22, further comprising:
a client detection module constructed to detect the projection area by corner detection using an image capture device which captures an image of the projection surface; and
a client maximum area module constructed to determine the area information comprising the maximum area rectangle within the projection area detected by the client detection module.

24. The projection client according to claim 22, wherein the projection client determines area information comprising the maximum area rectangle by calculations that include an aspect ratio of an image for projection at the projection client.

25. The projection client according to claim 21, further comprising:
a client splitting module constructed to divide an image for projection at the projection client into sub-images for projection at the projection client by each projector in the projector array based on the layout information.

26. The projection client according to claim 21, further comprising:
a client keystone correction module constructed to determine a keystone correction for the projection array of the projection client.

27. The projection client according to claim 21, wherein the layout information comprises the layout itself.

28. A control method in a projection server for a projection system distributed on a network, wherein the projection system comprises at least one projection client, and wherein the client hosts a projector array of multiple projectors which together project a tiling of an image onto a projection surface, the control method comprising:
accepting an incoming request from the projection client via the network, wherein the request provides the projection server with area information for a projection area of the projector array onto the projection surface;
determining a layout for the image by calculations using the area information; and
transmitting layout information based on the layout via the network to the projection client in response to the request,
wherein the projection client projects image data in accordance with the layout information received from the projection server.

29. The control method according to claim 28, wherein the projection client includes an image capture device which captures an image of the projection surface,
wherein the area information comprises an image of the projection surface and an image of the area projected by each projector in the projector array, and
wherein the request also provides the projection server with a resolution of each projector in the projector array and information specifying a location of each projector in the projector array.

30. The control method according to claim 29, further comprising:
detecting the projection area of the projection client by corner detection using the area information comprising the image of the projection surface and the image of the area projected by each projector in the projector array; and
determining the maximum area rectangle within the detected projection area.

31. The control method according to claim 28, wherein the layout is determined by calculations that include an aspect ratio of an image for projection at the projection client.

32. The control method according to claim 28, further comprising:
dividing an image for projection at the projection client into sub-images for projection at the projection client by each projector in the projector array based on the layout information.

33. The control method according to claim 28, further comprising:
determining a keystone correction for the projector array of the projection client.

34. The control method according to claim 28, wherein the layout information comprises image data for sub-images for projection at the projection client by each projector in the projector array.

35. A control method in a projection client for a projection system distributed on a network, wherein the projection system comprises at least one projection client, and wherein the projection client hosts a projector array of multiple projectors which together project a tiling of an image onto a projection surface, the control method comprising:
transmitting a request via the network to the projection server, wherein the request provides the projection server with area information for a projection area of the projector array onto the projection surface;
receiving layout information based on a layout, wherein the projection server determines the layout for the image by calculations using the area information; and
projecting image data in accordance with the layout information received from the projection server

36. The control method according to claim 35, wherein the area information comprises a maximum area rectangle within the projection area of the projector array onto the projection surface.

37. The control method according to claim 36, further comprising:
capturing an image of the projection surface, wherein the projection client includes an image capture device which captures an image of the projection surface;
detecting the projection area of the projection client by corner detection using the image capture device; and
determining the area information comprising the maximum area rectangle within the detected projection area.

38. The control method according to claim 36, wherein the projection client determines the area information comprising the maximum area rectangle by calculations that include an aspect ratio of an image for projection at the projection client.

39. The control method according to claim 35, further comprising:
dividing an image for projection at the projection client into sub-images for projection at the projection client by each projector in the projector array based on the layout information.

40. The control method according to claim 35, further comprising:
determining a keystone correction for the projection array of the projection client.

41. The control method according to claim 35, wherein the layout information comprises the layout itself.

42. A computer-readable memory medium on which is stored computer-executable process steps for causing a computer to control a projection server for a projection system distributed on a network, wherein the projection system comprises at least one projection client, and wherein the projection client hosts a projector array of multiple projectors which together project a tiling of an image onto a projection surface, the process steps comprising:
a reception step of accepting an incoming request from the projection client via the network, wherein the request provides the projection server with area information for a projection area of the projector array onto the projection surface;
a layout determination step of determining a layout for the image by calculations using the area information; and
a transmission step of transmitting layout information based on the layout via the network to the projection client in response to the request,
wherein the projection client projects image data in accordance with the layout information received from the projection server.

43. The computer-readable memory medium according to claim 42, wherein the projection client includes an image capture device which captures an image of the projection surface,
wherein the area information comprises an image of the projection surface and an image of the area projected by each projector in the projector array, and
wherein the request also provides the projection server with a resolution of each projector in the projector array and information specifying a location of each projector in the projector array.

44. The computer-readable memory medium according to claim 43, the process steps further comprising:
a detection step of detecting the projection area of the projection client by corner detection using the area information comprising the image of the projection surface and the image of the area projected by each projector in the projector array; and
a determination step of determining the maximum area rectangle within the detected projection area.

45. The computer-readable memory medium according to claim 42, wherein the layout is determined by calculations that include an aspect ratio of an image for projection at the projection client.

46. The computer-readable memory medium according to claim 42, the process steps further comprising:
a splitting step of dividing an image for projection at the projection client into sub-images for projection at the projection client by each projector in the projector array based on the layout information.

47. The computer-readable memory medium according to claim 42, the process steps further comprising:
a keystone correction step of determining a keystone correction for the projector array of the projection client.

48. The computer-readable memory medium according to claim 42, wherein the layout information comprises image data for sub-images for projection at the projection client by each projector in the projector array.

49. A computer-readable memory medium on which is stored computer-executable process steps for causing a computer to control a projection client for a projection system distributed on a network, wherein the projection system comprises at least one projection client, and wherein the projection client hosts a projector array of multiple projectors which together project a tiling of an image onto a projection surface, the process steps comprising:
a transmission step of transmitting a request via the network to the projection server, wherein the request provides the projection server with area information for a projection area of the projector array onto the projection surface;
a reception step of receiving layout information based on a layout, wherein the projection server determines the layout for the image by calculations using the area information; and
a projection step of projecting image data in accordance with the layout information received from the projection server.

50. The computer-readable memory medium according to claim 49, wherein the area information comprises a maximum area rectangle within the projection area of the projector array onto the projection surface.

51. The computer-readable memory medium according to claim 50, the process steps further comprising:
a capture step of capturing an image of the projection surface, wherein the projection client includes an image capture device which captures the image of the projection surface;
a detection step of detecting the projection area of the projection client by corner detection using the image capture device; and
a determination step of determining the area information comprising the maximum area rectangle within the detected projection area.

52. The computer-readable memory medium according to claim 50, wherein the projection client determines the area information comprising the maximum area rectangle by calculations that include an aspect ratio of an image for projection at the projection client.

53. The computer-readable memory medium according to claim 49, the process steps further comprising:
a splitting step of dividing an image for projection at the projection client into sub-images for projection at the projection client by each projector in the projector array based on the layout information.

54. The computer-readable memory medium according to claim 49, the process steps further comprising:
a keystone correction step of determining a keystone correction for the projection array of the projection client.

55. The computer-readable memory medium according to claim 49, wherein the layout information comprises the layout itself.
